(19) United States
(12) Patent Application Publication
(10) Pub. No.: US 2001/0030405 A1
(43) Pub. Date: Oct. 18, 2001

(54) Folding structure of a scooter

(76) Inventors: Yao-Ming Wu, Chang-Hua Hsien (TW); Xian-Rong Wu, Chang-Hua Hsien (TW)

Correspondence Address: BACON & THOMAS, PLLC, 625 Slaters Lane-4th Floor, Alexandria, VA, 22314-1176, US

(21) Appl. No.: 09/768,222

(22) Filed: Jan. 25, 2001

(30) Foreign Application Priority Data
Feb. 3, 2000 (TW) 089202339

(51) Int. Cl. B62M 1/00

(52) U.S. Cl. 280/87.041; 280/87.021

(57) ABSTRACT

The present invention discloses a foldable structure of a scooter, which can be operated with one hand, and the scooter comprises a bottom module having a front wheel, wherein a handle control rod of the coupling frame being extended from the rear end of the bottom module, and a tail module having a rear wheel with a footrest. By passing the axle through such members, the handle control rod and the footrest are latched to form a coupling base, and the foldable structure of the scooter characterized in that the coupling base has two positioning holes on one of its sides, and an arc sliding groove on the other side, and a fixing structure latched with the coupling base inside the coupling frame, and such fixing structure is the link rod passed through by a spring inside the coupling frame. Such link rod passes to the other end of the spring and mounted onto a connector, and the connector latches into the positioning hole of the coupling base by the tension of the spring, and the coupling frame is latched into the coupling base. As the link rod moves outwards to the side, it will carry the connector and compress the spring, so that the connector is separated from the positioning hole of the coupling base, and the handle control rod can be folded towards the direction of the footrest. Such arrangement enables the user to use one hand to operate the folding structure of the scooter without the risk of hurting his/her fingers.

### BACKGROUND OF THE INVENTION

1. Field of the Invention

The present invention relates to a folding structure of a scooter, more particularly to a folding structure that can be operated by one hand. The present invention basically improves the traditional folding structure that requires both hands for the operation by moving a link rod sideway towards the outside, and it will carry the connector and compress the spring thereby detaching the connector from the fixing hole of the coupling base and enabling the user to fold the handle control rod towards the direction of the footrest. Such arrangement can fold the scooter with a single hand operation without the risk of hurting the user's fingers.

2. Description of the Related Art

To meet with the trend, a scooter having both functions for fun and for exercise purposes is generally designed very similar to those as shown in FIGS. 1 and 2. The traditional scooter mainly has a handle and a footrest extended from the bottom end, and a coupling base that latches the handle and the footrest. By having the latching axle 71 pass through the coupling base 6 and the coupling frame 5, and an arc tracked groove 61 being disposed at the position corresponding to the coupling base. A blocking groove 62 being disposed on the arc tracked groove, and a blocking post 72 being disposed inside the arc tracked groove for the positioning, and then a spring 73 being extended such that both ends separately hook into the middle section of the latching axle 71 and the blocking post 72. The elasticity of the spring produces an elastic pulling force such that the blocking post 72 will remain hooked into the blocking groove 62 under normal condition. If the blocking post is removed from the blocking groove, the blocking post will slide along the arc-tracked groove so that it attains the purpose of folding the handle into the position. However, such structure has the following shortcomings:

1. The operation is very cumbersome. Due to the tension produced by the elastic pulling force of the spring, the blocking post 62 will remain latched into the blocking groove 62 under normal condition. When a user wants to fold the handle and the footrest, he/she must exert equal force on both ends of the coupling base to move the blocking post from the blocking groove so that the blocking post 72 can slide along the arc tracked groove 61 to attain the purpose of folding the handle into position. When folding the handle, the user must step on both side of the footrest and then use both hands to exert the force to pull the blocking post. There is no way for the user to fold the scooter by a single hand from a side of the scooter. Therefore, it makes the folding very cumbersome. Furthermore, it is not easy to control the folding operation, and the handle of the scooter may hit the user if it is not operated properly.

2. It is not safe for the usage. Due to the conventional scooter needs both hands to pull the blocking post in order to fold the handle, however the blocking post itself is pulled by the elastic spring, and the spring has a large tension to mount the blocking post in position. Therefore, the user needs to exert an action of larger force to pull the blocking post, and it may clip the thumb located on both inner side when the blocking post is pulled.

In summation of the above description, the inventor bases on years of his experience in this field to conduct research to solve the problems and break through the bottlenecks of the traditional folding structure of the scooter.

### SUMMARY OF THE INVENTION

The primary objective of the present invention is to provide a folding structure of a scooter that can be operated by a single hand, by making use of two positioning holes that are disposed on one of the lateral sides of the coupling base, and a sliding groove on the other side, and a fixing structure latched to the coupling base is being disposed inside the coupling base, and such fixing structure is the link rod passed through by a spring inside the coupling frame. Such link rod passes to the other end of the spring and mounted onto a connector, and the connector latches into the positioning hole of the coupling base by the tension of the spring, and the coupling frame is latched into the coupling base. As the link rod moves outwards to the side, it will carry the connector and compress the spring, so that the connector is separated from the positioning hole of the coupling base, and the handle control rod can be folded towards the direction of the footrest. Such arrangement enables the user to operate the folding structure of the scooter with one hand.

Another objective of the present invention is to provide a folding structure of a scooter that can be operated by a single hand without the risk of hurting the user's fingers. By moving the link rod outward, it will carry the connector to compress the spring, and separate the link axle from the positioning hole of the coupling base, and allows the user to fold handle control rod together with the coupling base towards the direction of the footrest. Therefore, the present invention no longer needs both hands for the traditional operation, and it also provides a way of folding the scooter without the risk of clipping the user's fingers.

To make it easier for our examiner to understand the objective of the invention, its structure, innovative features, and its performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 is a three-dimensional diagram of the traditional scooter.

FIG. 2 is a planar diagram showing the motion of folding structure of a traditional scooter.

FIG. 3 is a three-dimensional diagram of the disassembled parts of a preferred embodiment of the present invention.

FIG. 4 is a three-dimensional diagram of the assembled preferred embodiment of the present invention.

FIG. 5 is a planar diagram showing the motion of a preferred embodiment of the present invention when the coupling frame is being latched.

FIG. 5A shows a supplementary side-view of FIG. 5.

FIG. 6 is a planar diagram showing the motion of a preferred embodiment of the present invention when the coupling frame is sliding.

FIG. 6A shows a supplementary side-view of FIG. 6.

FIG. 7 is a planar diagram showing part of a preferred embodiment of the present invention.

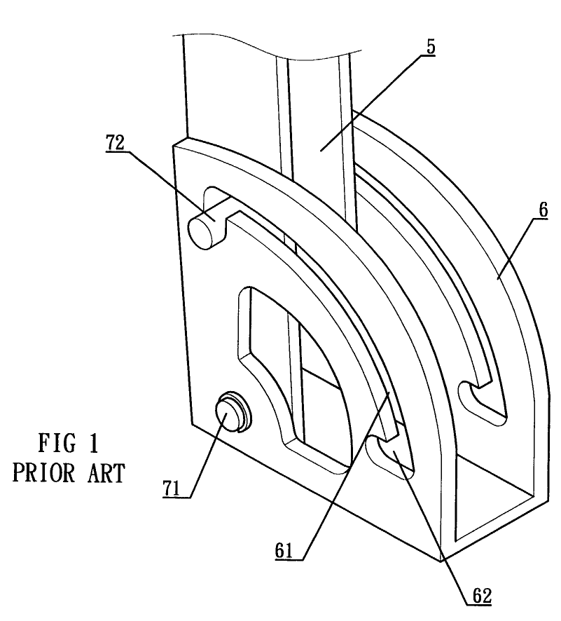

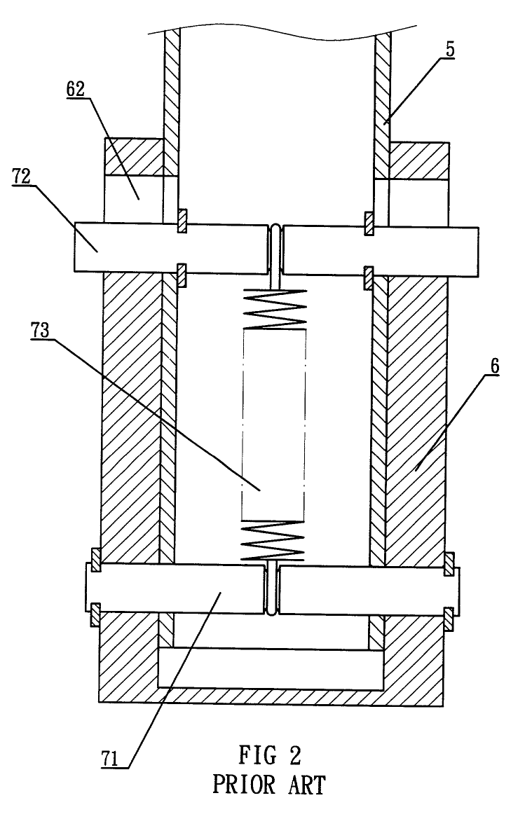

### DETAILED DESCRIPTION OF THE PREFERRED EMBODIMENTS

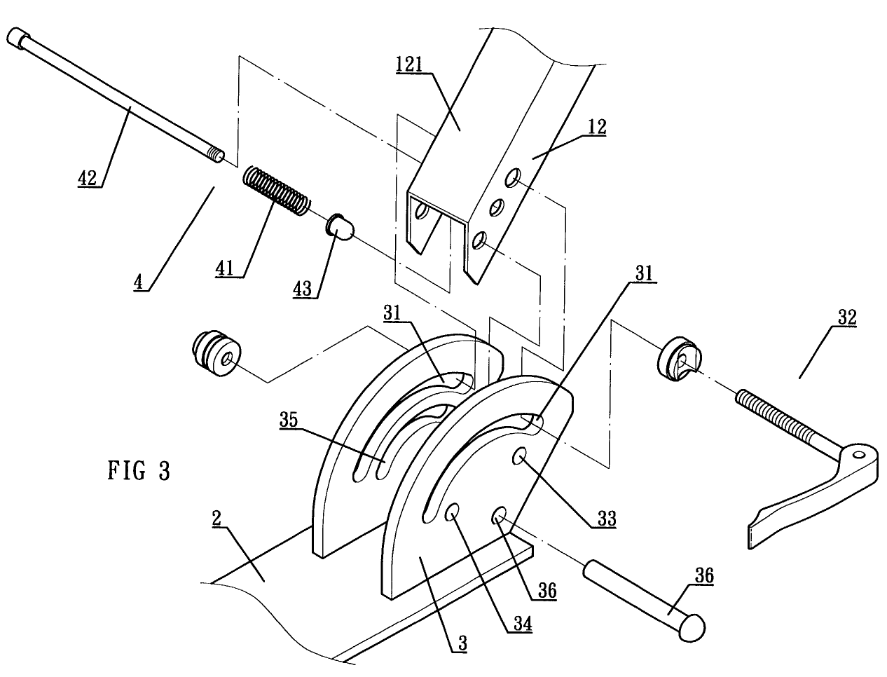

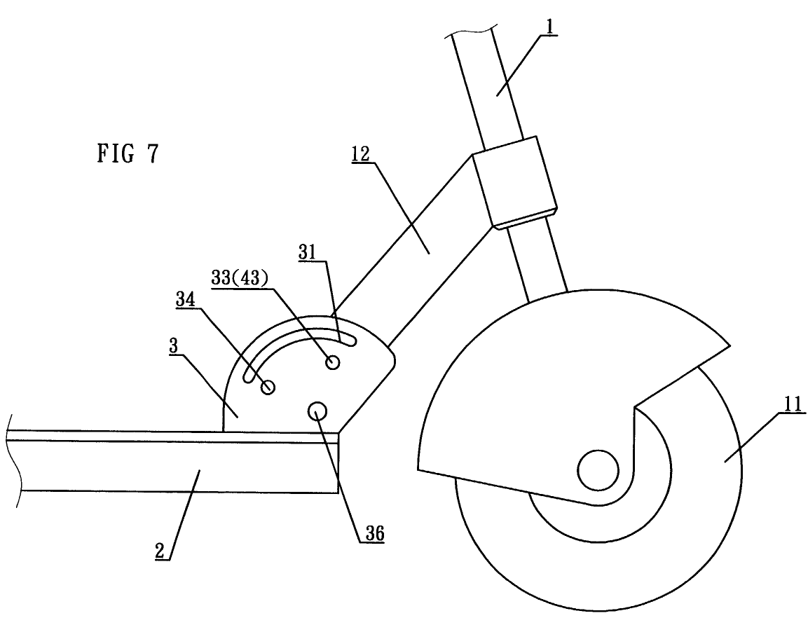

Please refer to FIGS. 3, 4, and 7. The present invention mainly comprises a bottom module having a front wheel 11, wherein a handle control rod 1 of the coupling frame 12 being extended from the rear end of the bottom module; a tail module having a rear wheel with a footrest 2; and a coupling base that couples the handle control rod and the footrest, and an axle 36 passing through the parts so that the handle control rod 1 and the footrest 2 are latched to the coupling base 3; wherein an arc tracked groove 31 for the sliding of a quick release 32 being disposed on the lateral sides of the coupling base 3, and such quick release 32 is for securely positioning the coupling frame 12 and the coupling base 13, characterized in that the coupling base 12 has an inclined groove 121 being disposed at an appropriate location in the front end of the coupling base, and in corresponding to the coupling frame 12, the coupling base 3 has an upper and a lower positioning holes 33, 34 on one of its sides for the latching of a fixing structure, and an arc sliding groove 35 on the other side; such fixing structure 4 is composed by passing the spring 41 within the coupling frame 12 and the link rod 42 of the spring 41, and such link rod 42 passes through the spring to the other end and being mounted onto a connector 43, and the connector 43 latches into the upper positioning hole 33 of the coupling base by the tension of the spring, and the coupling frame 12 is latched into the coupling base 3.

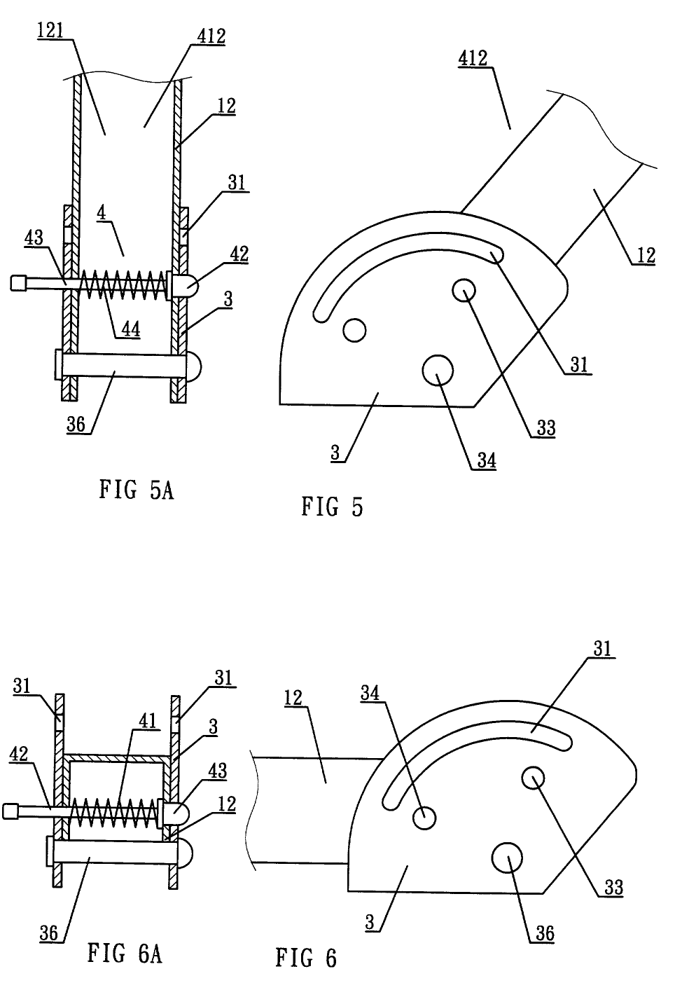

Please refer to FIGS. 5 and 6. When the user wants to fold the handle control rod 1 towards the direction of the footrest 2, all he/she has to do is move the link rod 42 outward to a side, and it will carry the connector 43 and compress the spring 41, so that the connector 43 is separated from the upper positioning hole 33 of the coupling base, as shown in FIG. 5, and the coupling frame can carry the handle control rod towards the direction of the footrest for the folding. When the handle control rod and the footrest are attached after folding, release the linking axle 42. At that time, the connector 43 will be latched into the lower positioning hole 34 due to the resuming force, as shown in FIG. 6. The quick release 42 securely presses the coupling frame and the coupling base, and it thereby enables the user to use one hand to operate the folding structure of the scooter without the risk of hurting his/her fingers.

Therefore in summation of the above description, the present invention herein enhances the performance of the conventional wrench structure and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved folding structure of a scooter, comprising a bottom module having a front wheel, wherein a handle control rod of the coupling frame being extended from the rear end of the bottom module; a tail module having a rear wheel with a footrest; and a coupling base that couples the handle control rod and the footrest, and an axle passing through the parts so that the handle control rod 1 and the footrest are latched to the coupling base, wherein a quick release being disposed on the lateral sides of the coupling base, characterized in that the coupling base has an inclined groove being disposed at an appropriate location in the front end of the coupling base, and in corresponding to the coupling base, the coupling base has an upper and a lower positioning holes on one of its sides for the latching of a fixing structure, and an arc sliding groove on the other side; such fixing structure is the link rod passed through by a spring inside the coupling frame; and such link rod passes to the other end of the spring and mounted onto a connector, and the connector latches into the positioning hole of the coupling base by the tension of the spring, and the coupling frame is latched into the coupling base, and as the link rod moves outwards to the side, it will carry the connector and compress the spring, so that the connector is separated from the positioning hole of the coupling base, and the handle control rod can be folded towards the direction of the footrest, thereby such arrangement enables the user to use one hand to operate the folding structure of the scooter without the risk of hurting his/her fingers.
